(19) United States
(12) Patent Application Publication
(10) Pub. No.: US 2007/0119684 A1
(43) Pub. Date: May 31, 2007

(54) BILL ACCEPTOR FOR MONEY EXCHANGING MACHINE

(75) Inventor: Wen-Fu Yang, TAIPEI (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Nei-Hu District, Taipei City (TW)

(21) Appl. No.: 11/164,601

(22) Filed: Nov. 30, 2005

(51) Int. Cl. G07F 9/10

(52) U.S. Cl. 194/350

(57) ABSTRACT

A bill acceptor used in a money exchanging machine is disclosed to include a bill box for collecting bills, and a bill receiving and verification unit, which has a bill slot for receiving bills, a first bill passage extending from the bill slot, a second bill passage extending from one end of the first bill passage remote from the bill slot, a conveyer for carrying each inserted bill from the bill slot through the first bill passage to the second bill passage and then pushing the bill into the bill box, and a sensor for detecting the presence of a bill in the bill box.

### BACKGROUND OF THE INVENTION

1. Field of the Invention

The present invention relates to a money-exchanging machine and more particularly, to a bill acceptor for money exchanging machine, which gives an indication when there is bill(s) in the bill box.

2. Description of the Related Art

Following fast development of transportation and communication technology, business in non-shop business has become popular. Nowadays, various automatic vending machines are used everywhere to sell different products without serviceman. The use of automatic vending machines creates new marketing routes for the suppliers, and gives convenience to consumers.

Further, an automatic vending machine may be provided with a money-exchanging machine. A money-exchanging machine for this purpose comprises a bill acceptor that uses a verification device to verify the authenticity of the inserted bill. Further, the bill acceptor may be equipped with a counter or micro-switch to detect the full status of the bill box. However, it is complicated to design a counter to count if the designed amount of bills has been received in the bill box or not. The maintenance work of such a counter is also complicated. Further, a micro-switch for detecting full status of the bill box may fail easily after a certain period in use.

A bill box detecting structure is disclosed. According to this design, this bill box detecting structure uses solenoid-detecting means to detect full status of the bill box. The solenoid-detecting means comprises a solenoid switch mounted in the bill box, and a magnetic member mounted in the pressure board corresponding to the solenoid switch. This bill box detecting structure is functional, however it is not durable in use because the magnetic force of the magnetic member attenuates gradually with the use of the bill box detecting structure, resulting in reduced sensitivity and false action. Further, the internal metal and electronic elements of the money-exchanging machine may interfere with the operation of the solenoid switch, causing the solenoid switch unable to function normally.

Further, the bill acceptor of a conventional automatic vending machine controls bill authenticity verification, anti-theft operation, money return operation, and coin/bill counting operation. According to conventional designs, the worker cannot know if the bill box is empty or not before opening it.

### SUMMARY OF THE INVENTION

The present invention has been accomplished under the circumstances in view. According to one aspect of the present invention, the bill acceptor is used in a money exchanging machine, comprising a bill box for collecting bills, and a bill receiving and verification unit, which has a bill slot for receiving bills, a first bill passage extending from the bill slot, a second bill passage extending from one end of the first bill passage remote from the bill slot, a conveyer for carrying each inserted bill from the bill slot through the first bill passage to the second bill passage and then pushing the bill into the bill box, and a sensor for detecting the presence of a bill in the bill box. According to another aspect of the present invention, the conveyer comprises a reversible motor, conveying belt means adapted to carry each inserted bill from the bill slot through the first bill passage to the second bill passage, a transmission gear train coupled between the reversible motor and the conveying belt means and adapted to rotate the conveying belt means upon clockwise rotation of the reversible motor, a crossed linkage connected to a pressure board and adapted to move the pressure board in and out of the bill box across the second bill passage, and a camshaft coupled between the reversible motor and the crossed linkage and adapted to reciprocate the cross linkage upon counter-clockwise rotation of the reversible motor. The bill receiving and verification unit further comprises a detector adapted to detect the accumulation status of bills in the bill box and to cut off power supply from the money exchanging machine when a predetermined amount of bills is accumulated in the bill box.

### BRIEF DESCRIPTION OF THE DRAWINGS

FIG. 1 is an elevational view of a bill acceptor according to the present invention.

FIG. 2 is an exploded view of the bill receiving and verification unit of the bill acceptor according to the present invention.

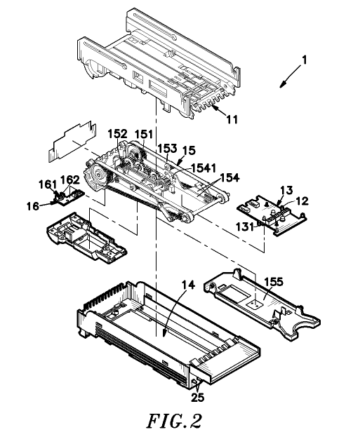

FIG. 3 is an exploded of the bill box of the bill acceptor according to the present invention.

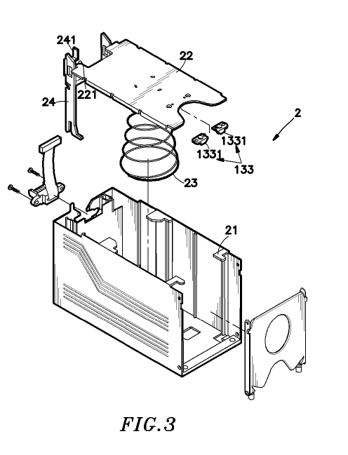

FIG. 4 is an exploded view of a part of the present invention, showing the structure of the sensor.

FIG. 5 is a schematic drawing showing the refracting action of the refracting elements of the refractor of the sensor according to the present invention.

FIG. 6 is a sectional side view of the present invention, showing the status of the bill acceptor upon insertion of a bill into the bill slot.

FIG. 7 is similar to FIG. 6 but showing the inserted bill carried to the first bill passage.

FIG. 8 is similar to FIG. 6 but showing the inserted bill carried to the second bill passage.

FIG. 9 is a schematic drawing of the present invention, showing the operation of the crossed linkage of the conveyer (I).

FIG. 10 is a schematic drawing of the present invention, showing the operation of the crossed linkage of the conveyer (II).

FIG. 11 is a schematic drawing of the present invention, showing the operation of the crossed linkage of the conveyer (III).

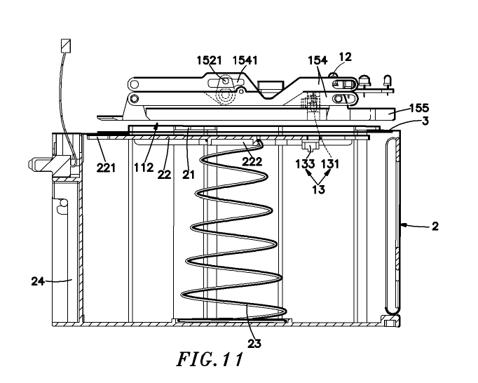

FIG. 12 is a perspective view of a part of the present invention, showing a small amount of bills received in the bill box.

FIG. 13 is similar to FIG. 12 but showing the full status of the bill box.

### DETAILED DESCRIPTION OF THE PREFERRED EMBODIMENT

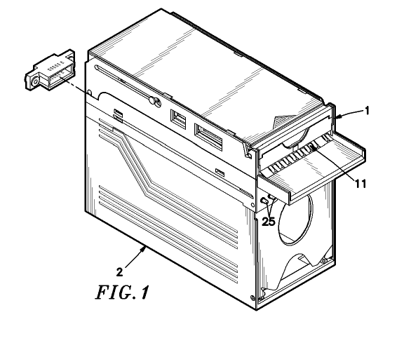

Referring to FIGS. 1˜4 and 7, a bill acceptor in accordance with the present invention is shown comprised of a bill receiving and verification unit 1 and a bill box 2.

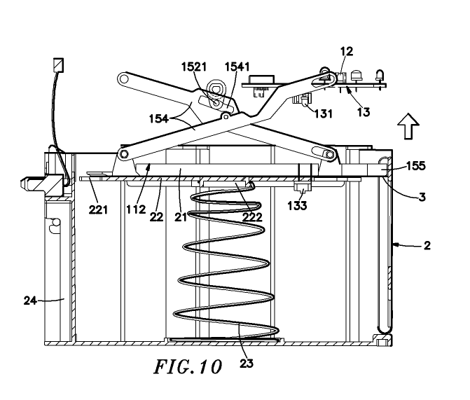

The bill receiving and verification unit 1 comprises a bill slot 11 through which a bill is inserted, an accommodating chamber 14, a first bill passage 111 extending from the bill slot 11, a second bill passage 112 in communication with the accommodating chamber 14, a verification device 12 set around the connection area between the bill slot 11 and the first bill passage 111 for verifying the authenticity of the inserted bill, a sensor 13 disposed at one side of the second bill passage 112 and adapted to detect the presence of a bill in the second bill passage 112, a conveyer 15 set in between the first bill passage 111 and the second bill passage 112 and adapted to convey the inserted bill 3 from the bill slot 11 to the second bill passage 112, and a detector 16. The bill conveyer 15 comprises a motor 151, a transmission gear train 152 coupled to the motor 151, two conveying belts 153 coupled to the transmission gear train 152, a camshaft 1521 coupled to the motor 151, a pressure board 155, and a crossed linkage 154 coupled between the camshaft 1521 and the pressure board 155 and adapted to move the pressure board 155 in and out of the accommodating chamber 14. The camshaft 1521 has one end inserted through a sliding slot 1541 at the crossed linkage 154 (see also FIG. 10). The detector 16 comprises a through hole 161 and a plurality of sensor elements 162.

The bill box 2 is mounted in the accommodating chamber 14 of the bill receiving and verification unit 1 with an open side thereof facing the second bill passage 112, having a plurality of stop rods 21 suspending around the open side, a flat bearing board 22 movably suspending on the inside, a spring member 23 mounted on the inside and fastened to a bottom connection hole 222 at the bottom side of the flat bearing board 22 to force the flat bearing board 22 upwards toward the stop rods 21 and the pressure board 155 of the bill receiving and verification unit 1, a sliding bar 24 fastened to a protruding block 221 at one side of the bearing board 22 for synchronous movement with the bearing board 22. The sliding bar 24 has a block 241 corresponding to the through hole 161 of the detector 16. Further, an indicator 25 is disposed on the outside of the bill box 2.

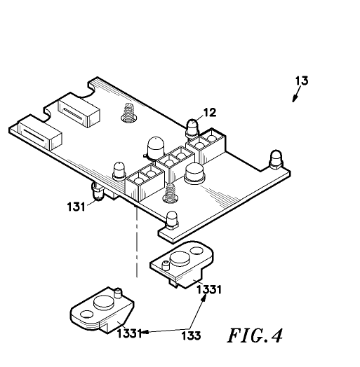

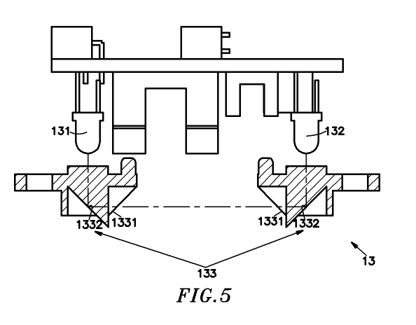

Referring to FIG. 5 and FIG. 4 again, the sensor 13 comprises an emitter 131, a receiver 132, and a refractor 133. The refractor 133 comprises a plurality of refracting elements, for example, two refracting elements 1331. Each refracting element 1331 has a refraction surface 1332. The refraction surface 1332 of the first refracting element 1331 refracts the light of the emitter 131 onto the refraction surface 1332 of the second refracting element 1331, and the refraction surface 1332 of the second refracting element 1331 refracts the light onto the receiver 132.

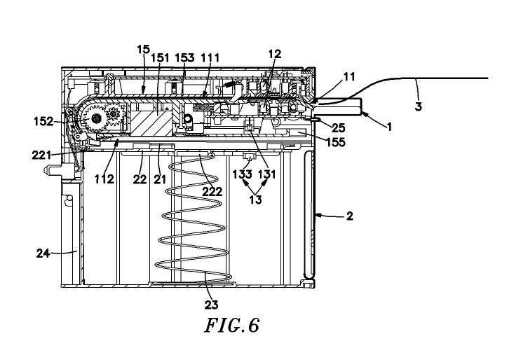

Referring to FIGS. 6˜8, when no bill 3 is in presence in the bill box 2, the receiver 132 receives the light refracted from the emitter 131 by the refractor 133, thereby driving the indicator 25 to produce an indication signal indicative of the empty status of the bill box 2. At this time, the money-exchanging machine starts to work. When a bill 3 is inserted into the bill slot 11, the verification device 12 immediately verifies the authenticity of the inserted bill 3. If the inserted bill 3 is a counterfeit or cannot be verified, the conveyer 15 is operated to return the inserted bill 3 to the bill slot 11. If the inserted bill 3 is verified to be authentic, the conveyer 15 is operated to carry the inserted bill 3 through the first bill passage 111 to the second bill passage 112. At this time, the emitter 131 of the sensor 13 is blocked by the inserted bill 3, and the receiver 132 of the sensor 13 receives no signal, and therefore the sensor 13 give a signal to the indicator 25, causing the indicator 25 to produce a corresponding indicator indicative of the presence of a bill in the second bill passage 112.

The aforesaid sensor 13 is adapted to detect the presence of a bill in the second bill passage 112. As indicated above, the sensor 13 according to this embodiment is comprised of an emitter 131 adapted to emit light, and a receiver 132 adapted to receive the light of the emitter 131. The sensor 13 may be made in other alternate forms that achieve the same effect.

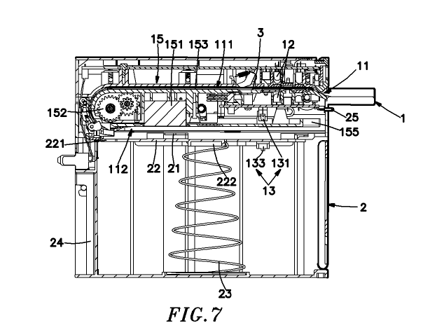

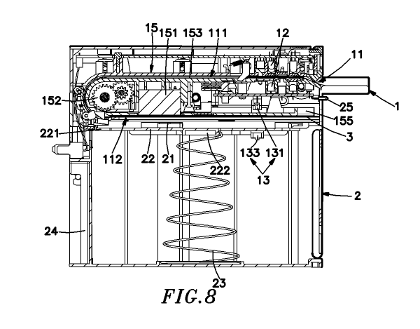

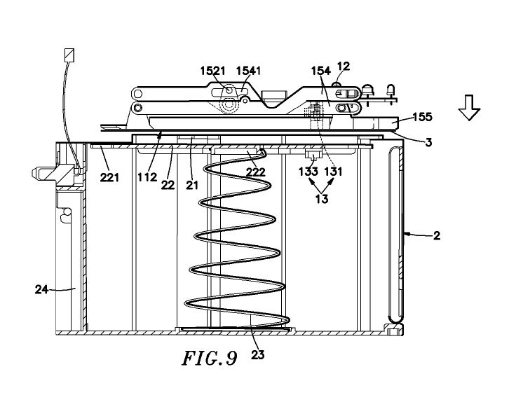

Referring to FIGS. 9˜11 and FIGS. 7 and 8 again, when a bill 3 is inserted into the bill slot 11, the motor 151 of the bill conveyer 15 is rotated clockwise to drive the transmission gear train 152 to rotate the conveying belts 153 and to further carry the inserted bill 3 from the first bill passage 111 to the second bill passage 112. After the bill 3 has been carried to the second bill passage 112, the motor 151 is reversed to rotate the camshaft 1521 and to further move the crossed linkage 154, thereby causing the crossed linkage 154 to extend out, and therefore the pressure board 155 is moved by the crossed linkage 154 to force the bill 3 out of the second bill passage 112 toward the bearing board 22 against the spring member 23. After the bill 3 has been set in the bill box 2, the motor 151 is continuously rotated in the reversed direction to drive the camshaft 1521 against the sliding slot 1541 of the crossed linkage 154, thereby returning the cross linkage 154 from the extended position to the received position to return the pressure board 155 to its former position, allowing the received bill 3 to be stopped between the bearing board 22 and the top rods 21 of the bill box 2 by means of the effect of the spring force of the spring member 23.

According to this embodiment, the spring member 23 is a spiral spring. Other spring means may be used as a substitute.

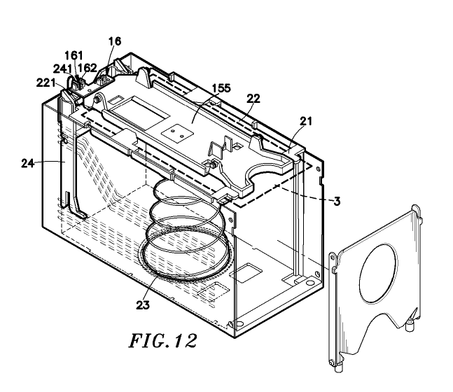

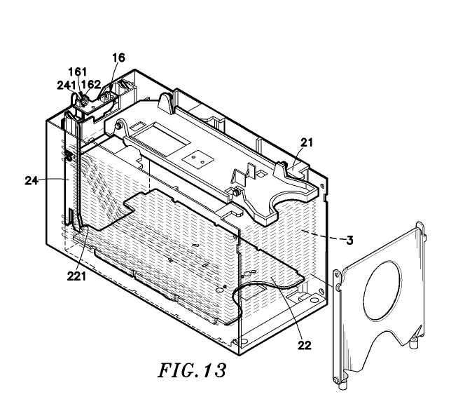

Referring to FIGS. 12 and 13, when the sliding bar 24 of the bill box 2 is moved with the bearing board 22 into the through hole 161 of the detector 16, the block 241 of the sliding bar 24 blocks the sensor elements 162. At this time, the bill box 2 is not fully filled with bills 3, and the detector 16 gives no signal to the indicator 25. When bills 3 are continuously delivered to the bill box 2 and stopped between the bearing board 22 and the top rods 21, the elevational position of the bearing board 22 in the bill box 2 is relatively lowered. After the bill box 2 received a predetermined number of bills 3, the sliding bar 24 is spaced from the through hole 161, and the sensor elements 162 are induced to give a signal to the indicator 25, causing the indicator 25 to produce an indication indicative of the full status of the bill box 2. At this time, the detector 16 cuts off power supply from the money-exchanging machine. After the worker has taken the storage bills 3 out of the bill box 2 and put the empty bill box 2 back into the accommodating chamber 14 of the bill receiving and verification unit 1, the indicator 16 is induced to give an indication indicative of the empty status of the bill box 2, and power supply is electrically connected to the money exchanging machine again.

As indicated above, the bill acceptor of the present invention has the following characteristics.

1. When the bill box 2 is empty, the receiver 132 of the sensor 13 receives the light refracted from the emitter 131 by the refractor 133, and therefore the receiver 132 gives a signal to the indicator 25 and the money exchanging machine, causing the indicator 25 to produce an indication indicative of the empty status of the bill box 2 and the money exchanging machine to start working.

2. When a bill 3 is received in the bill box 2, the bill 3 blocks the receiver 132 from receiving the light refracted from the emitter 131 by the refractor 133, and therefore the receiver 132 gives a signal to the indicator 25, causing the indicator 25 to produce an indication indicative of the presence of bill (bills) 3 in the bill box 2.

3. When a bill 3 is inserted into the bill slot 11, the motor 151 of the bill conveyer 15 is rotated clockwise to drive the transmission gear train 152 to rotate the conveying belts 153 in one direction, causing the conveying belts 153 to carry the inserted bill 3 from the bill slot 11 through the first bill passage 111 to the second bill passage 112. After the inserted bill 3 has been carried to the second bill passage 112, the motor 151 is reversed to rotate the camshaft 1521, causing the camshaft 1521 to move the crossed linkage 154 from the received position to the extended position, and therefore the pressure board 155 is moved to force the bill 3 out of the second bill passage 112 toward the bearing board 22 of the bill box 2.

4. After the bill box 2 has received a predetermined amount of bills 3, the sliding bar 24 is moved away from the through hole 161 of the detector 16, and therefore the sensor elements 162 of the detector 16 are induced to give a signal to the indicator 25, causing the indicator 25 to produce an indication indicative of the full status of the bill box 2.

A prototype of bill acceptor has been constructed with the features of FIGS. 1˜13. The bill acceptor functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bill acceptor used in a money exchanging machine, the bill acceptor comprising:
a bill box adapted to collect bills, said bill box comprising a plurality of stop rods suspending around an open side thereof, a bearing board adapted to receive bills, spring means, which supports said bearing board and imparts a forward pressure to said bearing board toward said stop rods; and
a bill receiving and verification unit, said bill receiving and verification unit comprising a bill slot for the insertion of bills, and a conveyer adapted to carry each inserted bill from said bill slot to said bearing board of said bill box, said conveyer comprising a pressure board movable relative to said bill box and adapted to press each inserted bill onto said bearing board for each received bill to be stopped between said bearing board and said stop rods of said bill box;
wherein said bill receiving and verification unit further comprises a first bill passage extending from said bill slot, a second bill passage extending from one end of said first bill passage remote from said bill slot and disposed in communication with said open side of said bill box between said bearing board and said pressure board, and a sensor adapted to detect the presence of a bill in said bill box.

2. The bill acceptor as claimed in claim 1, wherein said bill receiving and verification unit comprises a verification device set around the connection area between said bill slot and said first bill passage and adapted to verify the authenticity of each bill been inserted into said bill slot.

3. The bill acceptor as claimed in claim 1, wherein said sensor comprises an emitter suspending below said pressure board and adapted to emit light, a receiver suspending below said pressure board and adapted to receive light, and refractor means suspending above said bearing board and adapted to refract the light from said emitter onto said receiver.

4. The bill acceptor as claimed in claim 3, wherein said refractor comprises a first refracting element and a second refracting element, said first and second refracting elements each having a refraction surface, said refraction surface of said first refracting element being adapted to refract the light from said emitter onto said refraction surface of said second refracting element, said refection surface of said second refracting element being adapted to refract the refracted light from said refraction surface of said first refracting element onto said receiver.

5. The bill acceptor as claimed in claim 3, wherein said bill box comprises indicator means electrically connected to said sensor; said receiver drives said indicator means to produce a first indication indicative of the empty status of said bill box when said receiver is receiving the refracted light from said refractor, and drives said indicator means to produce a second indication indicative of the presence of at least one bill in said bill box when said receiver receives no refracted light from said refractor.

6. The bill acceptor as claimed in claim 1, wherein said conveyer comprises a reversible motor, conveying belt means adapted to carry each inserted bill from said bill slot through said first bill passage to said second bill passage, and a transmission gear train coupled between said reversible motor and said conveying belt means and adapted to rotate said conveying belt means upon clockwise rotation of said reversible motor.

7. The bill acceptor as claimed in claim 6, wherein said conveyer further comprises a crossed linkage connected to said pressure board and adapted to move said pressure board in and out of said bill box across said second bill passage, and a camshaft coupled between said reversible motor and said crossed linkage and adapted to reciprocate said cross linkage upon counter-clockwise rotation of said reversible motor.

8. The bill acceptor as claimed in claim 1, wherein said bill receiving and verification unit further comprises a detector adapted to detect the accumulation status of bills in said bill box and to cut off power supply from said money exchanging machine when a predetermined amount of bills is accumulated in said bill box, said detector comprising a through hole, a plurality of sensor elements; said bill box comprises a sliding bar movable with said bearing board in and out of said through hole of said detector, said sliding bar having a block, said block of said sliding bar blocking said sensor elements during the operation of said money exchanging machine and before said bill box has received said determined amount of bills, said block of said sliding bar being moved with said sliding bar and said bearing board away from said through hole of said detector for enabling said sensor elements to further cut off power supply from said money exchanging machine when said bill box has received said predetermined amount of bills.

9. The bill acceptor as claimed in claim 1, wherein said spring means is a spiral spring.
